(19) United States
(12) Patent Application Publication
(10) Pub. No.: US 2022/0111474 A1
(43) Pub. Date: Apr. 14, 2022

(54) ASSEMBLING SYSTEM OF BELT BUCKLE

(71) Applicant: Ho Yin LEUNG, Hong Kong (HK)

(72) Inventor: Ho Yin LEUNG, Hong Kong (HK)

(21) Appl. No.: 17/454,518

(22) Filed: Nov. 11, 2021

Related U.S. Application Data
(63) Continuation of application No. PCT/CN2021/075919, filed on Feb. 8, 2021.

(30) Foreign Application Priority Data
Oct. 13, 2020 (CN) 202011088283.1

(51) Int. Cl. B23P 21/00; B23P 19/00; B23P 19/027

(52) U.S. Cl. CPC B23P 21/004; B23P 2700/50; B23P 19/027; B23P 19/006

(57) ABSTRACT

An assembling system of a belt buckle is provided, which belongs to a field of belt buckle manufacturing. The assembling system of the belt buckle includes a main conveyor belt and a positioner mounted on the main conveyor belt, and the positioner is provided with a groove which can be matched with a lower cover of the belt buckle. The assembling system further includes a lower cover loading device, an upper cover loading and pressing device, a key loading plug-in device and a buckle loading plug-in device sequentially arranged along a conveying direction of the main conveyor belt. It provides high assembly efficiency.

### CROSS-REFERENCE TO RELATED APPLICATION(S)

This application is a continuation of co-pending International Patent Application No. PCT/CN2021/075919, filed on Feb. 8, 2021, which claims the priority and benefit of Chinese patent application number 202011088283.1, filed Oct. 13, 2020 with China National Intellectual Property Administration, the entire contents of which are incorporated herein by reference.

### TECHNICAL FIELD

The disclosure relates to a field of belt buckle manufacturing, in particular to an assembling system of a belt buckle.

### BACKGROUND ART

A belt is a safety device, which binds a body of a driver or a passenger to a seat of a vehicle so as to prevent the driver or the passengers from being injured by colliding with an inner wall of the vehicle due to accidents and other reasons.

In use, the driver or passenger pulls out the belt and fastens a buckle on the belt. Currently, in an assembly process of the belt buckle, it is made manually in most cases, in which an upper cover and a lower cover are clamped tightly, and then a key and the buckle are inserted between the upper cover and the lower cover respectively from gaps at front and rear ends of the upper cover and the lower cover, which is cumbersome in process and inefficient in manual assembly.

### SUMMARY

The disclosure provides an assembling system of a belt buckle, which provides high assembly efficiency.

Embodiments of the disclosure can be realized as follows.

An assembling system of a belt buckle is provided in an embodiment of the disclosure, which includes a main conveyor belt, a lower cover loading device, an upper cover loading pressing device, a key loading plug-in device and a buckle loading plug-in device.

The main conveyor belt is provided with a plurality of positioners, and the positioners are provided with grooves which can be matched with a lower cover of the belt buckle.

The lower cover loading device, the upper cover loading and pressing device, the key loading plug-in device and the buckle loading plug-in device are sequentially arranged along a conveying direction of the main conveyor belt.

The lower cover loading device is configured to convey the lower cover into grooves of the positioners of the main conveyor belt.

The upper cover loading and pressing device is configured to convey the upper cover of the belt buckle to a top of the lower cover on the positioners on the main conveyor belt, and can press and assemble the upper cover and the lower cover.

The key loading plug-in device is configured to plug a key of the belt buckle between the upper cover and the lower cover for assembly.

The buckle loading plug-in device is configured to plug the belt buckle between the upper cover and the lower cover for assembly.

Further, the upper cover loading and pressing device includes an upper cover conveyor belt, a second bracket, a second electric cylinder, a second air cylinder and a second vacuum cup.

The upper cover conveyor belt is arranged on a side of the main conveyor belt and perpendicular to the main conveyor belt, and the second bracket is arranged on a side of the upper cover conveyor belt.

The second electric cylinder and the second air cylinder are installed on the second bracket, and a power output of the second electric cylinder is drivingly connected with the second air cylinder for driving the second air cylinder to reciprocate linearly along a conveying direction of the upper cover conveyor belt, a stroke direction of the second air cylinder is a height direction of the upper cover conveyor belt, and a power output of the second air cylinder is connected with the second vacuum cup.

Further, the upper cover loading and pressing device also includes a pressing mechanism and a clamping mechanism. The clamping mechanism is configured to clamp both sides of the upper cover so that both sides of the upper cover are attached to the lower cover. The pressing mechanism is configured to tightly press the upper cover and the lower cover so that the upper cover is clamped on the top of the lower cover.

Further, the clamping mechanism includes two clamping arms arranged crosswise, a limiting member, a third electric cylinder and a third air cylinder.

The third electric cylinder and the lower cover conveyor belt are respectively arranged on two opposite sides of the main conveyor belt, and a stroke direction of the third electric cylinder is perpendicular to a conveying direction of the main conveyor belt. A power output of the third electric cylinder is provided with a slider.

The two clamping arms are hinged to the slider, the third air cylinder is installed on the slider, a telescopic rod of the third air cylinder is inserted into rear ends of the two clamping arms, and the limiting member is connected with an end of the telescopic rod for limiting the clamping arms.

A return spring is arranged between the two clamping arms and sleeved on the telescopic rod, and the return spring enables the two clamping arms to be in an open state.

Further, balls are installed at front ends of the two clamping arms.

Further, the pressing mechanism includes a fourth air cylinder and a fifth air cylinder. The power output end of the second electric cylinder is connected with a slider, the fourth air cylinder and the fifth air cylinder are both vertically installed on the slider, and the fourth air cylinder and the fifth air cylinder are located at two opposite sides of the second air cylinder. Power outputs of the fourth air cylinder and the fifth air cylinder are both connected with elastic pressing blocks, and bottoms of the pressing blocks have curved surfaces matched with a top of the upper cover.

Further, the lower cover loading device includes a lower cover conveyor belt, a first bracket, a first electric cylinder, a first air cylinder and a first vacuum cup.

The lower cover conveyor belt is arranged on a side of the main conveyor belt and perpendicular to the main conveyor belt, and the first bracket is arranged on a side of the lower cover conveyor belt.

The first electric cylinder and the first air cylinder are both installed on the first bracket, and a power output of the first electric cylinder is drivingly connected with the first air cylinder for driving the first air cylinder to reciprocate linearly along a conveying direction of the lower cover conveyor belt, a stroke direction of the first air cylinder is a height direction of the lower cover conveyor belt, and a power output of the first air cylinder is connected with the first vacuum cup.

Further, an end of the upper cover conveyor belt and/or the lower cover conveyor belt proximate to the main conveyor belt is provided with a positioning mechanism. The positioning mechanism includes two swing arms and a sixth air cylinder drivingly connected with each of the swing arms, each of the swing arms is hinged with a base of the conveyor belt corresponding to the upper cover conveyor belt and the lower cover conveyor belt, the sixth air cylinder is arranged on two opposite sides of the upper cover conveyor belt and the lower cover conveyor belt, an output end of the sixth air cylinder is provided with a T-shaped column, and one side of the swing arm and one side of the sixth air cylinder is provided with a T-shaped groove. The T-shaped column is clamped with the T-shaped groove and is slidably connected with the T-shaped groove.

Further, the key loading plug-in device includes a key conveyor belt, a third bracket, a fourth electric cylinder and a seventh air cylinder.

The key conveyor belt is installed on a side of the main conveyor belt and perpendicular to the main conveyor belt, and the third bracket is installed on a side of the key conveyor belt. A first slideway is provided between the key conveyor belt and the main conveyor belt, and the first slideway is provided with an upward inclined guide slope extending from an end of the key conveyor belt to the main conveyor belt, and the end of the guide slope of the first slideway corresponds to an area between the upper cover and the lower cover on the main conveyor belt.

The fourth electric cylinder is installed on the third bracket and its stroke direction is parallel to a conveying direction of the key conveyor belt. The seventh air cylinder is installed on a slider at a power output of the fourth electric cylinder. The power output of the seventh air cylinder is installed with a push plate for pushing the key to move along the first slideway. The seventh cylinder is configured to drive the push plate to lift.

Further, the buckle loading plug-in device includes a buckle conveyor belt, a fourth bracket, a fifth electric cylinder and an eighth air cylinder.

The buckle conveyor belt is installed at a side of the main conveyor belt and perpendicular to the main conveyor belt, and the fourth bracket is arranged at a side of the buckle conveyor belt. A second slideway is provided between the buckle conveyor belt and the main conveyor belt, and the second slideway is provided with an upward inclined guide slope extending from an end of the buckle conveyor belt to the main conveyor belt, and the end of the guide slope of the second slideway corresponds to an area between the upper cover and the lower cover on the main conveyor belt.

The fifth electric cylinder is installed on the fourth bracket and its travel direction is parallel to a conveying direction of the buckle conveyor belt. The eighth air cylinder is installed on a slider at a power output of the fifth electric cylinder. The power output of the eighth air cylinder is installed with a base. The eighth air cylinder is configured to drive the base to lift.

A first rubber block and a second rubber block are provided in parallel at intervals at a bottom of the base, the first rubber block is fixed to the base, the second rubber block is movably inserted into the base through a connecting rod and can move relative to the base, the connecting rod is sleeved with a push spring, and the second rubber block can be inserted into a hole of the buckle.

Embodiments of the disclosure provide advantages that:

With the assembling system according to the embodiments of the disclosure, the belt buckle can be can quickly assembled, effectively improving assembly efficiency of the belt buckle and reducing labor cost.

### BRIEF DESCRIPTION OF THE DRAWINGS

In order to illustrate technical schemes of embodiments of this disclosure more clearly, the following drawings used in the embodiments will be briefly introduced; it should be understood that the following drawings only show some embodiments of this disclosure, therefore they should not be regarded as a limiting of the protection scope.

FIG. 1 is a schematic diagram of a three-dimensional structure of an assembling system of a belt buckle according to an embodiment of the present disclosure;

FIG. 2 is a schematic diagram of a three-dimensional structure of an assembling system of a belt buckle according to an embodiment of the present disclosure;

FIG. 3 is a schematic diagram of a three-dimensional structure of a lower cover loading device according to an embodiment of the disclosure;

FIG. 4 is a partial structural schematic diagram of the upper cover loading and pressing device according to an embodiment of the disclosure;

FIG. 5 is a schematic diagram of a three-dimensional structure of a clamping mechanism of the upper cover loading and pressing device according to the embodiment of the disclosure;

FIG. 6 is a schematic diagram of a three-dimensional structure of a key loading plug-in device according to an embodiment of the disclosure;

FIG. 7 is a schematic diagram of a three-dimensional structure of a buckle loading plug-in device according to an embodiment of the disclosure;

FIG. 8 is a partial structural schematic diagram of a buckle loading plug-in device according to an embodiment of the disclosure;

FIG. 9 is a schematic diagram of a three-dimensional structure of a base according to an embodiment of the present disclosure.

### REFERENCE NUMBER

1a—Upper cover; 1b—Lower cover; 1c—Key; 1d—Buckle; 2—Main Conveyor Belt; 2a—Positioner; 2b—Limiting Member; 3—Lower Cover Loading Device; 3a—Lower Cover Conveyor Belt; 3b—First Bracket; 3c—First Electric Cylinder; 3d—First Air Cylinder; 3e—First Vacuum Cup; 4—Upper Cover Loading and Pressing Device; 4a—Upper Cover Conveyor Belt; 4b—Second Bracket; 4c—Second Electric Cylinder; 4d—Second Air Cylinder; 4e—Second Vacuum Cup; 5—Key Loading Plug-in Device; 5a—Key Conveyor Belt; 5b—Third Bracket; 5c—Fourth Electric Cylinder; 5d—Seventh Air Cylinder; 5e—First Slideway; 5f—Push Plate; 6—Buckle Loading Plug-in Device; 6a—Buckle Conveyor Belt; 6b—Fourth Bracket; 6c—Fifth Electric Cylinder; 6d—Eighth Air Cylinder; 6e—Second Slideway; 6f—Base; 6g—First Rubber Block; 6h—Second Rubber Block; 6h1—Connecting Rod; 6h2—Push Spring; 7—Pressing Mechanism; 7a—Fourth Air Cylinder; 7b—Fifth Air Cylinder; 7c—Frame; 7d—Pressing Block; 8—Clamping Mechanism; 8a—Third Electric Cylinder; 8b—Clamping Arm; 8b1—Ball; 8c—Third Air Cylinder; 8d—Return Spring; 9—Positioning Mechanism; 9a—Swing Arm; 9a1—T-shaped Groove; 9b—Sixth Air Cylinder; 9c—T-shaped Column; 10a—Drive Motor; 10b—Stop Door.

### DETAILED DESCRIPTION

In order to make the purposes, technical schemes and advantages of embodiments of this disclosure more clear, the technical schemes in the embodiments of this disclosure will be described clearly and completely with reference to the drawings in the embodiments of this disclosure; and it is Obvious that the described embodiments are part of the embodiments of this disclosure, but not all of them.

On a basis of the embodiments in this disclosure, all other embodiments obtained by the ordinary skilled in the art without any creative effort are within the protection scope of this disclosure.

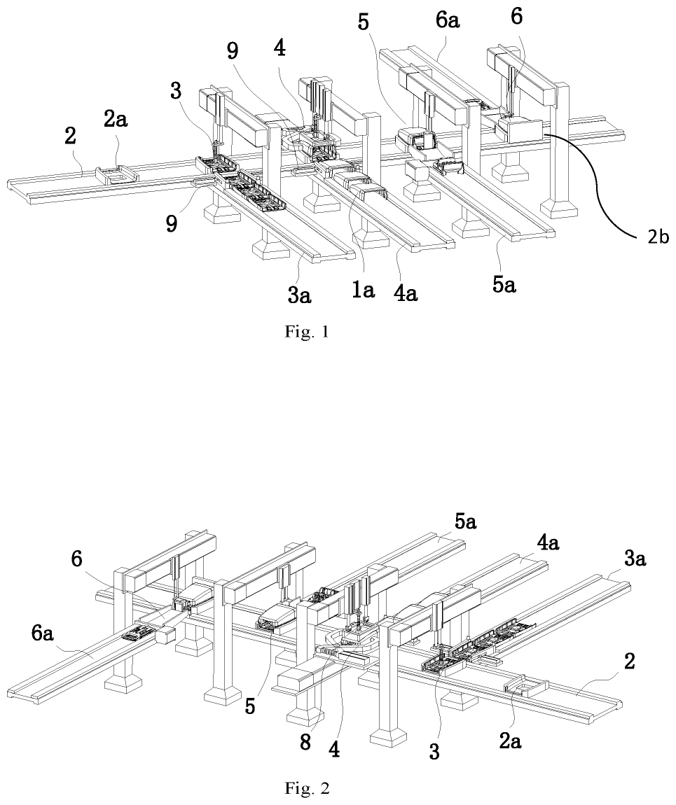

An assembling system of a belt buckle 1d is provided in an embodiment of this disclosure. Referring to FIGS. 1 and 2, the assembling system of the belt buckle 1d includes a main conveyor belt 2, and a lower cover loading device 3, an upper cover loading and pressing device 4, a key loading plug-in device 5 and a buckle loading plug-in device 6 sequentially arranged along a conveying direction of the main conveyor belt 2.

A lower cover loading station, an upper cover loading station, a key loading plug-in station and a buckle loading plug-in station are sequentially arranged along the conveying direction of the main conveyor belt 2. The main conveyor belt 2 is provided with a plurality of positioners 2a, and the positioners 2a are provided with grooves which can be matched with a lower cover 1b of the belt buckle 1d. Illustratively, the plurality of positioners 2a are installed on the main conveyor belt 2 at equal intervals. The grooves of the positioners 2a are similar to the lower cover 1b in appearance.

The lower cover loading device 3 is configured to convey the lower cover 1b into grooves of the positioners 2a of the main conveyor belt 2. The upper cover 1a loading device is configured to convey the upper cover 1a of the belt buckle 1d to a top of the lower cover 1b on the positioners 2a on the main conveyor belt 2, and can press and assemble the upper cover 1a and the lower cover 1b. The key loading plug-in device 5 is configured to plug a key 1c of the belt buckle 1d between the upper cover 1a and the lower cover 1b for assembly. The buckle loading plug-in device 6 is configured to plug the belt buckle 1d between the upper cover 1a and the lower cover 1b for assembly.

After the lower cover loading device 3 conveys the lower cover 1b to grooves of the positioners 2a of the main conveyor belt 2 at the lower cover 1b loading station, the main conveyor belt 2 continues to convey forward and then reaches the upper cover 1a loading station. The upper cover 1a loading device conveys the upper cover 1a of the belt buckle 1d to the top of the lower cover 1b on the positioner 2a on the main conveyor belt 2, and presses and assembles the upper cover 1a and the lower cover 1b; the main conveyor belt 2 continues to conveying forward, and then reaches the key 1c loading plug-in station. The key loading plug-in device 5 plugs the key 1c of the belt buckle 1d between the upper cover 1a and the lower cover 1b for assembly, and the main conveyor belt 2 continues to conveying forward and then reaches the buckle 1d loading plug-in station. The buckle loading plug-in device 6 serves to plug the belt buckle 1d between the upper cover 1a and the lower cover 1b for assembly. With the assembling system, the belt buckle 1d can be can quickly assembled, effectively improving assembly efficiency of the belt buckle 1d.

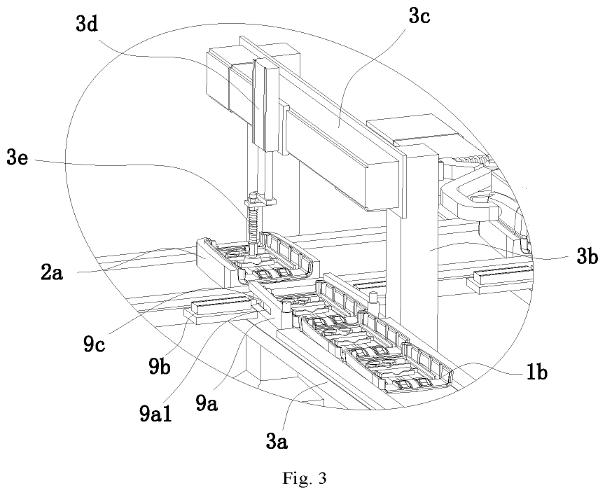

Further, referring to FIG. 3, the lower cover loading device 3 includes a lower cover conveyor belt 3a, a first bracket 3b, a first electric cylinder 3c, a first air cylinder 3d and a first vacuum cup 3e. The lower cover conveyor belt 3a is arranged on a side of the main conveyor belt 2 and perpendicular to the main conveyor belt 2, and the first bracket 3b is arranged on a side of the lower cover conveyor belt 3a.

The first electric cylinder 3c and the first air cylinder 3d are both installed on a top crossbeam of the first bracket 3b, and a power output of the first electric cylinder 3c is drivingly connected with the first air cylinder 3d for driving the first air cylinder 3d to reciprocate linearly along a conveying direction of the lower cover conveyor belt 3a. A power output of the first electric cylinder 3c is connected with a slider, and the first air cylinder 3d is vertically installed on the slider of the first electric cylinder 3c.

A stroke direction of the first air cylinder 3d is a height direction of the lower cover conveyor belt 3a, and a power output of the first air cylinder 3d is connected with the first vacuum cup 3e. The first vacuum cup 3e is driven by the first air cylinder 3d to ascend and descend, and driven by the first electric cylinder 3c to move in a horizontal direction, so that the lower cover 1b can be absorbed at an end of the lower cover conveyor belt 3a and then transferred to the positioners 2a of the main conveyor belt 2.

Further, please refer to FIGS. 1, 2 and 4, the upper cover loading and pressing device 4 includes an upper cover conveyor belt 4a, a second bracket 4b, a second electric cylinder 4c, a second air cylinder 4d and a second vacuum cup 4e. The upper cover conveyor belt 4a is arranged on a side of the main conveyor belt 2 and perpendicular to the main conveyor belt 2, and the second bracket 4b is arranged on a side of the upper cover conveyor belt 4a.

The second electric cylinder 4c and the second air cylinder 4d are installed on a top crossbeam of the second bracket 4b, and a power output of the second electric cylinder 4c is drivingly connected with the second air cylinder 4d for driving the second air cylinder 4d to reciprocate linearly along a conveying direction of the upper cover conveyor belt 4a, a stroke direction of the second air cylinder 4d is a height direction of the upper cover conveyor belt 4a, and a power output of the second air cylinder 4d is connected with the second vacuum cup 4e. The second vacuum cup 4e is driven by the second air cylinder 4d to ascend and descend and driven by the second electric cylinder 4c to move in the horizontal direction, so that the upper cover 1a can be adsorbed at an end of the upper cover conveyor belt 4a and then transferred to the top of the lower cover 1b on the positioners 2a of the main conveyor belt 2, and the a pre-pressing is made to the upper cover 1a.

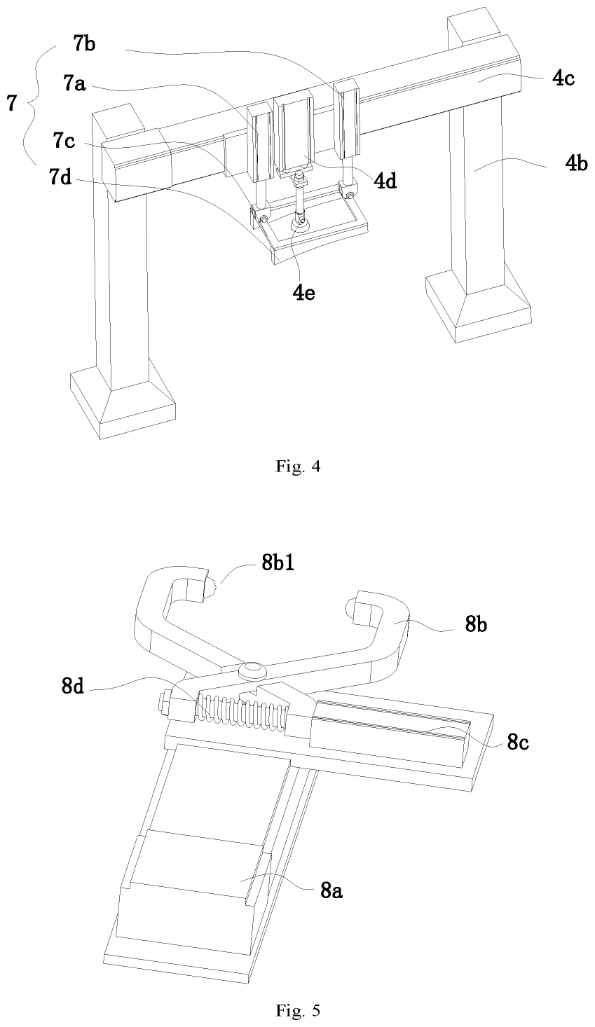

Further, referring to FIGS. 4 and 5, in a possible embodiment, the upper cover loading and pressing device 4 also includes a pressing mechanism 7 and a clamping mechanism 8. The clamping mechanism 8 is configured to clamp both sides of the upper cover 1a so that both sides of the upper cover 1a are attached to the lower cover 1b. The pressing mechanism 7 is configured to tightly press the upper cover 1a and the lower cover 1b so that the upper cover 1a is clamped on the top of the lower cover 1b.

Illustratively, the clamping mechanism 8 includes two clamping arms 8b arranged crosswise, a limiting member, a third electric cylinder 8a and a third air cylinder 8c. The third electric cylinder 8a and the lower cover conveyor belt 3a are respectively arranged on two opposite sides of the main conveyor belt 2, and a stroke direction of the third electric cylinder 8a is perpendicular to a conveying direction of the main conveyor belt 2. A power output of the third electric cylinder 8a is provided with a slider. The two clamping arms 8b are hinged to the slider. Illustratively, the two clamping arms 8b are hinged to the slider of the third electric cylinder 8a with a shaft passing through intersection of the two clamping arms.

The third air cylinder 8c is installed on the slider of the third electric cylinder 8a, and a telescopic rod of the third air cylinder 8c is inserted into rear ends of the two clamping arms 8b, and the limiting member is connected with an end of the telescopic rod for limiting the clamping arms 8b. A return spring 8b is arranged between the two clamping arms 8d and sleeved on the telescopic rod, and the return spring 8d enables the two clamping arms 8b to be in an open state.

In use, front ends of the two clamping arms 8b are driven by the third electric cylinder 8a to move to the main conveyor belt 2 and stay on the positioners 2a of the upper cover 1a loading and pressing station, so that the two clamping arms 8b are on both sides of the upper cover 1a, and the telescopic rod of the third air cylinder 8c is retracted to cause the two clamping arms 8b to clamp both sides of the upper cover 1a, so that the upper cover 1a can be clamped on the top of the lower cover 1b smoothly.

Illustratively, the pressing mechanism 7 includes a fourth air cylinder 7a and a fifth air cylinder 7b. The power output end of the second electric cylinder 4c is connected with a slider, the fourth air cylinder 7a and the fifth air cylinder 7b are both vertically installed on the slider 4c, and the fourth air cylinder 7a and the fifth air cylinder 7b are located at two opposite sides of the second air cylinder 4d. Power outputs of the fourth air cylinder 7a and the fifth air cylinder 7b are both connected with elastic pressing blocks 7d which correspond to positions on a top of the upper cover 1a proximate to its edge, and bottoms of the pressing blocks 7d have curved surfaces matched with the top of the upper cover 1a. Illustratively, the pressing block 7d is made of rubber. Optionally, the power outputs of the fourth air cylinder 7a and the fifth air cylinder 7b are each connected with a frame 7c, and the pressing block 7d is installed at a bottom of the frame 7c.

After the two clamping arms 8b of the clamping mechanism 8 clamp the two sides of the upper cover 1a, the fourth air cylinder 7a and the fifth air cylinder 7b drive the two pressing blocks 7d to move down to apply a pressing force to the two sides of the upper cover 1a, thereby clamping the upper cover 1a on the top of the lower cover 1b.

Optionally, balls 8b1 are installed at the front ends of the two clamping arms 8b. The balls 8b1 can be provided to avoid a too large clamping force of the two clamping arms 8b, thus a too large friction force between the upper cover 1a and the clamping arms 8b when the pressing block 7d is pressed down, which results in damage to an outer surface of the upper cover 1a.

Further, please referring to FIG. 3, an end of the upper cover conveyor belt 4a and/or the lower cover conveyor belt 3a proximate to the main conveyor belt 2 is provided with a positioning mechanism 9. The positioning mechanism 9 includes two swing arms 9a and a sixth air cylinder 9b drivingly connected with each of the swing arms 9a, each of the swing arms 9a is hinged with a base of the conveyor belt corresponding to the upper cover conveyor belt 4a and the lower cover conveyor belt 3a, the sixth air cylinder 9b is arranged on two opposite sides of the upper cover conveyor belt 4a and the lower cover conveyor belt 3a, an output end of the sixth air cylinder 9b is provided with a T-shaped column 9c, and one side of the swing arm 9a and one side of the sixth air cylinder 9b is provided with a T-shaped groove 9a1. The T-shaped column 9c is clamped with the T-shaped groove 9a1 and is slidably connected with the T-shaped groove 9a1.

The two swing arms 9a rotate around their own hinge points with the corresponding sixth air cylinders 9b, so that the two swing arms 9a approach to pose workpieces on their corresponding conveyor belts.

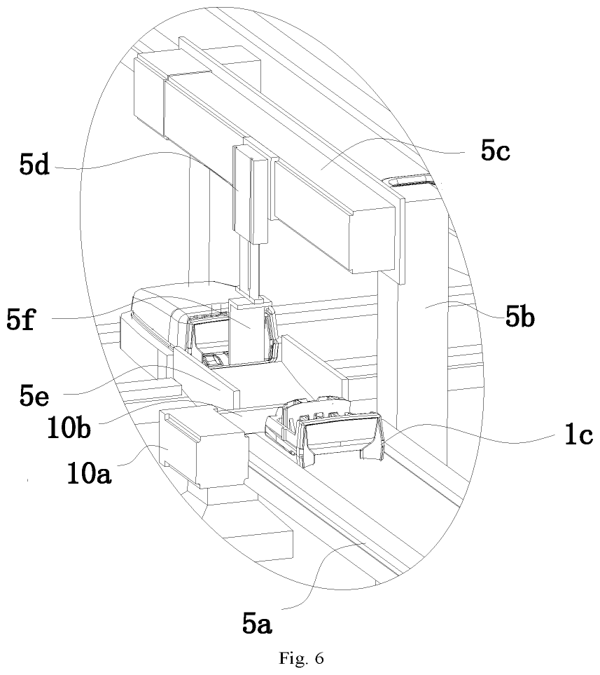

Further, referring to FIG. 6, the key loading plug-in device 5 includes a key conveyor belt 5a, a third bracket 5b, a fourth electric cylinder 5c and a seventh air cylinder 5d. The key conveyor belt 5a is installed at a side of the main conveyor belt 2 and perpendicular to the main conveyor belt 2, and the third bracket 5b is arranged at a side of the key conveyor belt 5a.

A first slideway 5e is arranged between the key conveyor 5a and the main conveyor 2. The first slideway 5e is provided with an upward inclined guide slope extending from an end of the key conveyor belt 5a to the main conveyor belt 2, and the end of the guide slope of the first slideway 5e corresponds to an area between the upper cover 1a and the lower cover 1b on the main conveyor belt 2.

The fourth electric cylinder 5c is installed on a top crossbeam of the third bracket 5b and its stroke direction is parallel to a conveying direction of the key conveyor belt 5a. The seventh air cylinder 5d is installed on a slider at a power output of the fourth electric cylinder 5c. The power output of the seventh air cylinder 5d is installed with a push plate 5f for pushing the key 1c to move along the first slideway 5e. The seventh cylinder 5d is configured to drive the push plate 5f to lift. Illustratively, the push plate 5f is L-shaped.

The push plate 5f is lifted by the seventh air cylinder 5d and moved to a back of a key 1c on an end of the key conveyor 5a, and the push plate 5f is driven by the fourth electric cylinder 5c to push the key 1c to be inserted between the upper cover 1a and the lower cover 1b along the guide slope on the first slideway 5e.

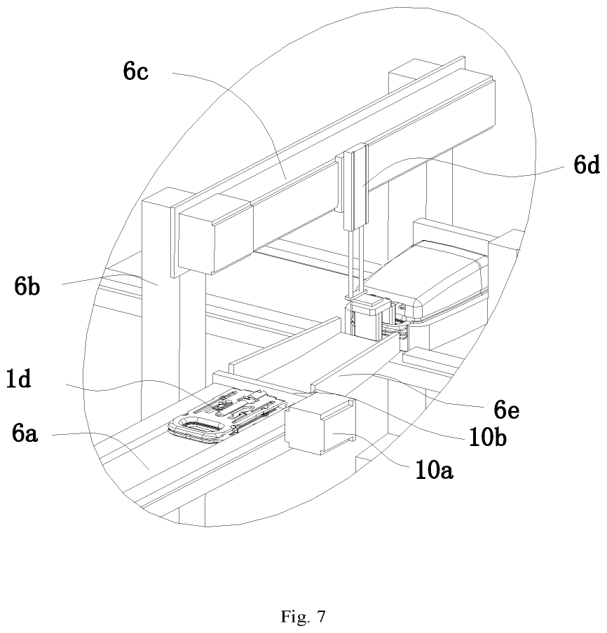

Further, referring to FIG. 7, the buckle loading plug-in device 6 includes a buckle conveyor belt 6a, a fourth bracket 6b, a fifth electric cylinder 6c and an eighth air cylinder 6d. The buckle conveyor belt 6a is installed at a side of the main conveyor belt 2 and perpendicular to the main conveyor belt 2, and the fourth bracket 6b is arranged at a side of the buckle conveyor belt 6a.

A second slideway 6e is provided between the buckle conveyor belt 6a and the main conveyor belt 2, and the second slideway 6e is provided with an upward inclined guide slope extending from an end of the buckle conveyor belt 6a to the main conveyor belt 2, and the end of the guide slope of the second slideway 6e corresponds to an area between the upper cover 1a and the lower cover 1b on the main conveyor belt 2. The fifth electric cylinder 6c is installed on a top crossbeam of the fourth bracket 6b and its travel direction is parallel to a conveying direction of the buckle conveyor belt 6a. The eighth air cylinder 6d is installed on a slider at a power output of the fifth electric cylinder 6c. The power output of the eighth air cylinder 6d is installed with a base 6f The eighth air cylinder 6d is configured to drive the base 6f to lift.

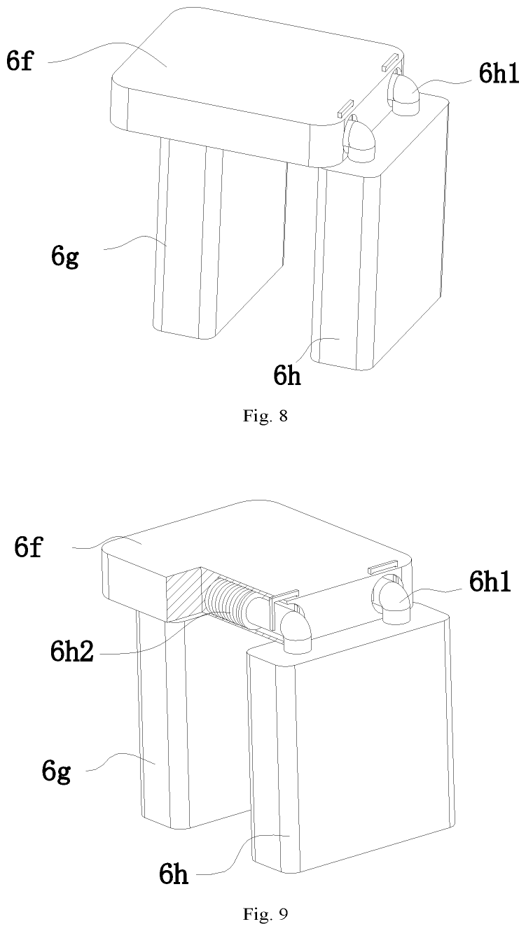

Referring to FIGS. 8 and 9, a first rubber block 6g and a second rubber block 6h are provided in parallel at intervals at a bottom of the base 6f, the first rubber block 6g is fixed to the base 6f, the second rubber block 6h is movably inserted into the base 6f through a connecting rod 6h1 and can move relative to the base 6f, the connecting rod 6h1 is sleeved with a push spring 6h2, and the second rubber block 6h can be inserted into a hole of the buckle 1d. Illustratively, the connecting rod 6h1 is L-shaped, the connecting rod 6h1 is provided as two in number, and each of the connecting rods 6h1 is sleeved with a push spring 6h2.

The second rubber block 6h horizontally extends out of the base 6f under an elastic force of the push spring 6h2. The first rubber block 6g and the second rubber block 6h are lifted by the eighth air cylinder 6d, and the second rubber block 6h can be inserted in clearance into a hole at the back of the buckle 1d in a operating state. The first rubber block 6g is located at the back of the buckle 1d and does not contact with the buckle 1d, and the second rubber block 6h is driven by the fifth electric cylinder 6c to push the buckle 1d to be inserted between the upper cover 1a and the lower cover 1b along the guide slope on the second slideway 6e. After the buckle is inserted into a certain position, a part of the hole at the back of the buckle 1d is moved between the upper cover 1a and the lower cover 1b, and the second rubber block 6h abuts against the upper cover 1a, the second rubber block 6h is in a static state relative to the upper cover 1a, and the first rubber block 6g gradually approaches and finally abuts against the back of the buckle 1d along with the movement of the fifth electric cylinder 6c. Instead of the second rubber block 6h, the first rubber block 6g completely inserts the buckle 1d in between the upper cover 1a and the lower cover 1b.

Optionally, referring to FIG. 1, a limiting block 2b is provided on a side of the main conveyor belt 2, and the limiting block 2b and the buckle conveyor belt 6a are located on two opposite sides of the main conveyor belt 2.

The limit block 2b is used to prevent the buckle 1d from transmitting a pushing force to the upper cover 1a and the lower cover 1b during assembly, thereby preventing the lower cover 1b from being pushed out of the positioners 2a.

Referring to FIG. 6, optionally, a drive motor 10a and a stop door 10b are installed at ends of the key conveyor belt 5a and/or the buckle conveyor belt 6a, and the stop door 10b is drivingly connected with the drive motor 10a, and the drive motor 10a can drive the stop door 10b to rotate in a plane perpendicular to the horizontal plane for isolating the key conveyor belt 5a and the buckle conveyor belt 6a. In this way, an assembled workpiece can be separated from a subsequent workpiece.

Optionally, the assembling system further includes a unloading mechanism, which includes a unloading conveyor belt and a unloading manipulator, and the unloading manipulator can grasp the belt buckle 1d of the main conveyor belt 2 to the unloading conveyor belt. The assembled belt buckle 1d can be sent to a next process by the unloading mechanism.

The above is only specific embodiments of this disclosure, and is not intended to limit this disclosure, and modifications and variations can be made in this disclosure for those skilled in the art. Any modification, equivalent substitution, improvement, etc. made within the spirit and principle of this disclosure shall be encompassed within the protection scope of this disclosure.

What is claimed is:

1. An assembling system of a belt buckle, comprising:
a main conveyor belt provided with a plurality of positioners, the positioners being provided with grooves which can be matched with a lower cover of the belt buckle; and
a lower cover loading device, an upper cover loading and pressing device, a key loading plug-in device and a buckle loading plug-in device sequentially arranged along a conveying direction of the main conveyor belt; wherein
the lower cover loading device is configured to convey the lower cover into grooves of the positioners of the main conveyor belt;
the upper cover loading and pressing device is configured to convey the upper cover of the belt buckle to a top of the lower cover on the positioners on the main conveyor belt, and presses and assembles the upper cover and the lower cover;
the key loading plug-in device is configured to plug a key of the belt buckle between the upper cover and the lower cover for assembly; and
the buckle loading plug-in device is configured to plug the belt buckle between the upper cover and the lower cover for assembly.

2. The assembling system of the belt buckle according to claim 1, wherein the upper cover loading and pressing device comprises an upper cover conveyor belt, a second bracket, a second electric cylinder, a second air cylinder and a second vacuum cup; wherein
the upper cover conveyor belt is arranged on a side of the main conveyor belt and perpendicular to the main conveyor belt, and the second bracket is arranged on a side of the upper cover conveyor belt; and
the second electric cylinder and the second air cylinder are installed on the second bracket, and a power output of the second electric cylinder is drivingly connected with the second air cylinder for driving the second air cylinder to reciprocate linearly along a conveying direction of the upper cover conveyor belt, a stroke direction of the second air cylinder is a height direction of the upper cover conveyor belt, and a power output of the second air cylinder is connected with the second vacuum cup.

3. The assembling system of the belt buckle according to claim 2, wherein the upper cover loading and pressing device further comprises a pressing mechanism and a clamping mechanism, wherein the clamping mechanism is configured to clamp both sides of the upper cover so that both sides of the upper cover are attached to the lower cover, the pressing mechanism is configured to tightly press the upper cover and the lower cover so that the upper cover is clamped on the top of the lower cover.

4. The assembling system of the belt buckle according to claim 3, wherein the clamping mechanism comprises two clamping arms arranged crosswise, a limiting member, a third electric cylinder and a third air cylinder; wherein
the third electric cylinder and the lower cover conveyor belt are respectively arranged on two opposite sides of the main conveyor belt, and a stroke direction of the third electric cylinder is perpendicular to a conveying direction of the main conveyor belt, a power output of the third electric cylinder is provided with a slider;
the two clamping arms are hinged to the slider, the third air cylinder is installed on the slider, a telescopic rod of the third air cylinder is inserted into rear ends of the two clamping arms, and the limiting member is connected with an end of the telescopic rod for limiting the clamping arms; and
a return spring is arranged between the two clamping arms and sleeved on the telescopic rod, and the return spring enables the two clamping arms to be in an open state.

5. The assembling system of the belt buckle according to claim 4, wherein balls are installed at front ends of the two clamping arms.

6. The assembling system of the belt buckle according to claim 3, wherein the pressing mechanism comprises a fourth air cylinder and a fifth air cylinder, wherein the power output end of the second electric cylinder is connected with a slider, the fourth air cylinder and the fifth air cylinder are both vertically installed on the slider, and the fourth air cylinder and the fifth air cylinder are located at two opposite sides of the second air cylinder, power outputs of the fourth air cylinder and the fifth air cylinder are both connected with elastic pressing blocks, and bottoms of the pressing blocks have curved surfaces matched with a top of the upper cover.

7. The assembling system of the belt buckle according to claims 2, wherein the lower cover loading device comprises a lower cover conveyor belt, a first bracket, a first electric cylinder, a first air cylinder and a first vacuum cup; wherein
the lower cover conveyor belt is arranged on a side of the main conveyor belt and perpendicular to the main conveyor belt, and the first bracket is arranged on a side of the lower cover conveyor belt; and
the first electric cylinder and the first air cylinder are both installed on the first bracket, and a power output of the first electric cylinder is drivingly connected with the first air cylinder for driving the first air cylinder to reciprocate linearly along a conveying direction of the lower cover conveyor belt, a stroke direction of the first air cylinder is a height direction of the lower cover conveyor belt, and a power output of the first air cylinder is connected with the first vacuum cup.

8. The assembling system of the belt buckle according to claim 7, wherein an end of the upper cover conveyor belt and/or the lower cover conveyor belt proximate to the main conveyor belt is provided with a positioning mechanism, the positioning mechanism comprises two swing arms and a sixth air cylinder drivingly connected with each of the swing arms, each of the swing arms is hinged with a base of the conveyor belt corresponding to the upper cover conveyor belt and the lower cover conveyor belt, the sixth air cylinder is arranged on two opposite sides of the upper cover conveyor belt and the lower cover conveyor belt, an output end of the sixth air cylinder is provided with a T-shaped column, and one side of the swing arm and one side of the sixth air cylinder is provided with a T-shaped groove, the T-shaped column is clamped with the T-shaped groove and is slidably connected with the T-shaped groove.

9. The assembling system of the belt buckle according to claim 1, wherein the key loading plug-in device comprises a key conveyor belt, a third bracket, a fourth electric cylinder and a seventh air cylinder; wherein
the key conveyor belt is installed on a side of the main conveyor belt and perpendicular to the main conveyor belt, and the third bracket is installed on a side of the key conveyor belt; a first slideway is provided between the key conveyor belt and the main conveyor belt, and the first slideway is provided with an upward inclined guide slope extending from an end of the key conveyor belt to the main conveyor belt, and the end of the guide slope of the first slideway corresponds to an area between the upper cover and the lower cover on the main conveyor belt; and
the fourth electric cylinder is installed on the third bracket and its stroke direction is parallel to a conveying direction of the key conveyor belt; the seventh air cylinder is installed on a slider at a power output of the fourth electric cylinder; the power output of the seventh air cylinder is installed with a push plate for pushing the key to move along the first slideway; and the seventh cylinder is configured to drive the push plate to lift.

10. The assembling system of the belt buckle according to claim 1, wherein the buckle loading plug-in device comprises a buckle conveyor belt, a fourth bracket, a fifth electric cylinder and an eighth air cylinder; wherein
the buckle conveyor belt is installed at a side of the main conveyor belt and perpendicular to the main conveyor belt, and the fourth bracket is arranged at a side of the buckle conveyor belt; a second slideway is provided between the buckle conveyor belt and the main conveyor belt, and the second slideway is provided with an upward inclined guide slope extending from an end of the buckle conveyor belt to the main conveyor belt, and the end of the guide slope of the second slideway corresponds to an area between the upper cover and the lower cover on the main conveyor belt;
the fifth electric cylinder is installed on the fourth bracket and its travel direction is parallel to a conveying direction of the buckle conveyor belt, the eighth air cylinder is installed on a slider at a power output of the fifth electric cylinder, the power output of the eighth air cylinder is installed with a base, and the eighth air cylinder is configured to drive the base to lift; and
a first rubber block and a second rubber block are provided in parallel at intervals at a bottom of the base, the first rubber block is fixed to the base, the second rubber block is movably inserted into the base through a connecting rod and can move relative to the base, the connecting rod is sleeved with a push spring, and the second rubber block can be inserted into a hole of the buckle.
